(19) United States
(12) Patent Application Publication
(10) Pub. No.: US 2025/0303608 A1
(43) Pub. Date: Oct. 2, 2025

(54) GLUE FOR BOARDS

(71) Applicant: UNILIN, BV, Wielsbeke (BE)

(72) Inventors: Koen NEL, Wielsbeke (BE); Gertjan VANCOILLIE, Wielsbeke (BE); Kenny MOUTON, Wielsbeke (BE)

(21) Appl. No.: 18/863,134

(22) PCT Filed: May 9, 2023
(86) PCT No.: PCT/IB2023/054785

§ 371 Date: Nov. 5, 2024

(30) Foreign Application Priority Data
May 10, 2022 (BE) 2022/5350
May 10, 2022 (BE) 2022/5351
Oct. 25, 2022 (BE) 2022/5862
Oct. 25, 2022 (BE) 2022/5863

(51) Int. Cl. B27N 3/06; B27N 3/00; B27N 3/02; B27N 3/04

(52) U.S. Cl. CPC B27N 3/06; B27N 3/002; B27N 3/007; B27N 3/02; B27N 3/04

(57) ABSTRACT

A board includes cellulose-containing materials, and a glue that bonds these cellulose-containing materials together. The glue is a glue based on amines, carbohydrates and additives, method for making the boards and a glue for the boards.

This invention relates to a board comprising cellulose-containing materials, such as vegetable fibres and/or wood chips and/or wooden parts, and a cured glue that bonds these cellulose-containing materials together. This invention also relates to a method for making a board of this kind, a glue for said boards and a method of manufacturing said glues.

This invention relates to boards comprising cellulose-containing materials. These cellulose-containing materials may comprise one or more of the following materials: wood fibres, wood chips, wood flakes, layers of wood, flax fibres, bamboo fibres, hemp fibres, wood waste derived from among other things the recycling of for example chipboards/wood fibreboards, etc. These cellulose-containing materials may thus for example be lignocellulose-containing materials. The boards are for example wood fibreboards, such as MDF—Medium Density Fibreboard—and HDF—High Density Fibreboard—, other wood-based boards such as chipboards, OSB (oriented strand board), multiplex boards, etc., and non-wood-based fibreboards, such as flax boards, bamboo boards, hemp boards, etc. These boards may or may not be formed partially or completely from recycled material, such as recycled lignocellulose-containing material. Thus, the cellulose-containing materials may comprise recycled materials derived from the recycling of for example chipboards, wood fibreboards or panels comprising such chipboards or wood fibreboards. Thus, chipboards may comprise particles of recycled chipboards or wood fibreboards may comprise particles of recycled wood fibreboards, such as recycled wood fibres.

The commonest glue used in the production of said boards is an aminoplast polymer, produced by a polycondensation reaction from urea and formaldehyde to a urea formaldehyde resin (UF resin). Optionally melamine is added and a melamine urea formaldehyde resin (MUF resin) is obtained, or melamine and phenol are added (MUPF resins: melamine urea phenol formaldehyde). The great advantages of these glues are their low cost—on account of the use of generally available and cheap raw materials in their preparation; and their high reactivity. Glues of this kind may release formaldehyde during and after polymerization, under the effect of temperature, moisture, or pH change. It is sought more and more to limit, or even to reduce to zero, the emission of formaldehyde from boards. Therefore formaldehyde-free glues for producing the aforementioned boards have been and are being sought.

US2006/0163769 describes the use of water glass as glue in the production of derived wood products that are fire-resistant.

A known formaldehyde-free glue for use in the production of derived wood products consists of polymeric methylene diphenyl diisocyanate (pMDI).

CA2019382A1 describes a mixture of isocyanate and a sufficient amount of metal soap to be used as glue in derived wood products. The metal soap is used as blocking compound to prevent reaction between water and isocyanate, therefore a sufficient amount of metal soap is necessary. CA2019382A1 further describes that for the mixture of isocyanate and the sufficient amount of metal soap, water glass may also be included in the mixture, to form an emulsion.

An additional drawback of all these aforementioned glues is that these are based on fossil raw materials.

There are already bio-based glues for boards, but the production of boards with the aid of these glues is less simple. Drawbacks are among others a reactivity that is too low, uncontrolled/undesirable prepolymerization, limited adhesiveness, poor wetting properties, in comparison with the common formaldehyde-containing aminoplast glues. Examples of bio-based glues are glues based on lignin, plant flour such as soya flour, or sugars.

This invention relates to a glue based on amines and carbohydrates, so that the cured glue present in the board comprises Maillard reaction products derived from the Maillard reaction between these amines and carbohydrates. The present invention aims firstly to optimize glues of this kind, and boards comprising glues of this kind.

According to a first aspect, the invention relates to a board comprising cellulose-containing materials, such as vegetable fibres and/or wood chips and/or wooden parts, and a cured glue that bonds these cellulose-containing materials together, wherein the cured glue is derived from a glue based on amines and carbohydrates and the cured glue comprises Maillard reaction products derived from the Maillard reaction between these amines and carbohydrates, wherein the glue further comprises additives for controlling the Maillard reaction. In order to form this board, use is made of a glue based on amines and carbohydrates, and comprising additives, wherein this glue is not yet cured or is not yet completely cured. During forming of the board, this glue will cure (further) so as to give a cured glue that bonds the cellulose-containing materials together. Here, “cured glue” means that the glue has undergone curing during forming of the board, it is sufficiently dry and it bonds the cellulose-containing materials together sufficiently so as to produce the desired board. This does not mean per se that the glue is cured completely. Here, a cured glue may or may not be a fully cured glue. With said boards, such as fibreboards, chipboards, OSB boards, multiplex boards, etc., heat is generated and/or added during production, for example during pressing of these boards. By means of the heat, the Maillard reaction is initiated and may thus cause further curing of the glue used. Here, “cured glue derived from a glue based on amines and carbohydrates” means the glue that arises after curing of the glue that is used for forming the boards.

The glue used for forming this board is based on said amines, carbohydrates and additives. This means that these amines, carbohydrates and additives will be provided during formation of the glue. Percentages, amounts, proportions of these amines, carbohydrates and additives are always expressed here on the basis of the amounts of dry matter that were provided for formation of the glue. This is because during formation of the glue it is possible that these amines and carbohydrates will already react (partially) with one another, prior to the use of the glue for forming the boards. Amounts of cellulose-containing materials are preferably expressed in dry matter of cellulose-containing materials, thus dry cellulose-containing materials, for example dry wood.

By means of the additives, the Maillard reaction is closely controlled, preferably during forming of the boards, so that the desired Maillard reaction products are formed and/or the desired reaction rate is obtained, so that the properties of the cured glue and so also the properties of the formed board are thus optimized. Thus, the additives may increase the reactivity of the glue and/or counteract undesirable prepolymerization and/or increase the adhesiveness of the cured glue. The result is a board with the desired tensile strength, bending strength, E-modulus etc. The additives thus provide a better glue. With the aid of this glue, we may choose to manufacture boards with better properties, in comparison with boards manufactured with existing glues based on carbohydrates and amines. However, we may also choose to use less glue, than with boards manufactured with existing glues based on carbohydrates and amines, to obtain similar properties. By means of said additives, we may also choose to lower the content of amines in the glue. Good results are obtained when the percentage by weight of amines in the total weight of amines and carbohydrates is at least 20. We may then for example choose to use less amines and thus choose a percentage by weight of amines in the total weight of amines and carbohydrates of at most 20 or at most 15, to obtain similar properties such as with boards manufactured with existing glues based on carbohydrates and amines.

The Maillard reaction is the general term for a complex series of chemical reactions that occur between reducing sugars and amines. The carbohydrates and the amines form Maillard reactants here. The aforementioned additives may or may not be used in the Maillard reaction, and thus may or may not form part of the Maillard reactants. One or more types of additives may be used.

Amines are chemical compounds that comprise at least one amine atomic group and so are a source of amines. The percentage by weight of the sum of dry matter of amines and dry matter of carbohydrates, which are used for formation of the glue, in the dry matter of cellulose-containing materials, is for example between 2 and 20, preferably between 3 and 15, even more preferably between 4 and 10. We are speaking here about dry matter of amines and dry matter of carbohydrates, which are used for formation of the glue, because during formation of the glue, thus during mixing of the ingredients of the glue, these ingredients may already react with one another, wherein for example water is formed, so that the dry matter content changes. The aforementioned amounts are also determined by the type of board, for example with three-layer chipboards comprising a central layer and two outer covering layers, said percentage by weight is for example in all layers between 3% and 12%, wherein the percentages by weight for the covering layers are always higher than the percentage by weight of the central layer. Thus, for the covering layers said percentage by weight may be for example 6, 7, 8, 9, 10, 11 or 12. For the central layer said percentage by weight may be for example 3, 4, 5, 6, 7 or 8. For MDF or HDF or OSB, this percentage by weight may be between 5 and 10, and thus may be for example 6, 7, 8 or 9.

The amines make up for example between 15 and 40 wt % of the total weight of amines and carbohydrates, preferably between 20 and 30 wt % or preferably between 35 and 40 wt %. The carbohydrates then make up between 60 and 85 wt % of the total weight of amines and carbohydrates, preferably between 70 and 80 wt % or preferably between 60 and 65 wt %. The amines may for example comprise diamines, such as hexamethylenediamine (HDMA), or amides comprising amine groups, or hyperbranched polyamides. Thus, the percentage by weight of amines in the total weight of amines and carbohydrates may be for example 22, 23, 24, 25, 26, 27, 28, 35, 36, 37 or 38.

The carbohydrates are and/or are converted to reducing sugars. Reducing sugars are necessary for the Maillard reaction. Thus, use may be made of sucrose, which for example is converted to glucose and fructose. Sucrose is a widely occurring sugar and is a cheap bio-based source of carbohydrate. It is possible to start from a 50 to 70 wt % solution of sucrose in water. It is also possible to start from invert sugar. The carbohydrates used may also comprise only glucose or comprise only fructose. Use may be made of a 65 to 75 wt % solution of invert sugar in water, for example a 70 wt % solution of invert sugar in water. This solution is then brought into contact with the amines.

A “glue based on carbohydrates and amines” means a glue whose dry matter consists largely of carbohydrates and amines, for example at least 50 wt % of carbohydrates and amines in the total weight of the dry matter, preferably at least 70 wt % and even more preferably at least 80 wt % and most preferably at least 90 wt %. Preferably said additives make up at most 20 wt %, preferably at most 10 wt % and most preferably at most 5 wt % of the total weight of dry matter.

During the making of the glue that is used for forming the board, the various ingredients of the glue are combined. This glue is then used to glue the cellulose-containing materials of the board so as to form the board. The aforementioned boards are usually formed by means of pressing, wherein heat is generated and/or is added during this pressing. The Maillard reaction takes place by means of this heat. It is possible that already prior to pressing, thus during formation of the glue, the Maillard reaction has already taken place partially, and the glue, during gluing of the cellulose-containing materials, already comprises Maillard reaction products. Thus, during the combining of ingredients of the glue, heat may already be added so that the Maillard reaction takes place. This has the advantage that during gluing, the glue already comprises some Maillard reaction products and thus the pressing time may possibly be shortened and/or the reactivity of the glue is higher. Thus, for example we may proceed as follows: first a prereact is prepared comprising the carbohydrates and a proportion of the amines. This prereact is heated (and/or the carbohydrates and/or said proportion of the amines is heated prior to combining to form the prereact). In this way, the Maillard reaction takes place during formation of this prereact and this prereact already has a number of Maillard reaction products. Then the remainder of the amines is added to form the glue, which is then used for gluing the cellulose-containing materials. This prereact may already comprise a number of additives or all additives. These additives may be added at the beginning of the formation of the prereact, but also may be added during formation of the prereact, as well as after formation of the prereact. When the additives are added may also depend on the type of additive. For formation of the prereact, for example between 5 and 40 wt % of the amines may be provided, for example between 15 and 40 wt %, for example between 20 and 30 wt %, for example between 10 and 20 wt %, such as 10, 11, 12, 13, 14, 15, 16, 17 or 18 wt %, in such a way that there are still sufficient amines present in the formed glue that have not yet reacted. If the additives comprise an acid or salts of an acid, for example chloric acid (such as HCl) or salts of a hypochlorous acid (such as NaOCl), and the carbohydrates comprise sucrose, then this acid or these salts of an acid are preferably added to the prereact so that sucrose is satisfactorily converted to glucose and fructose.

These cellulose-containing materials are preferably lignocellulose-containing materials. The vegetable fibres are for example wood fibres. These wood fibres may or may not be present in the form of wood fibre bundles.

Preferably use is made of only one first type of glues for forming the boards, namely glues based on said carbohydrates and amines, but the boards may also comprise other types of glues. Thus, use may be made of a glue mixture comprising the first type of glue and one or more other types of glues, and/or the board may be multilayer wherein for one said layer the first type of glue is used, and another type of glue is used for another said layer. Examples of other glues are for example conventional UF glues, MUF glues, MUPF glues, pMDI glues, polyurethane glues, polyvinylbutyral glues, polyacrylate glues, etc. Polyurethane glues may for example be used to increase the water resistance and/or flexibility. It is also possible that a board is formed with various glues of the first type of glue. Thus, the board may be multilayer, wherein different glues, but for example all glues based on said carbohydrates and amines, are used for the different layers. These last-mentioned various glues may be different on all kinds of surfaces. A non-exhaustive list of possible differences now follows, wherein these differences are combinable with one another so long as this is not incompatible: dry matter content, additives—which and quantities—, carbohydrates—which and quantities—, amines—which and quantities—, solvent used (water or solvent), etc.

Preferably the additives comprise bases. By means of bases, the pH during the Maillard reaction is controlled and it is thus achieved that the desired Maillard reaction products are formed. It was found, surprisingly, that potassium carbonate (K₂CO₃) is a very suitable base to use as an additive. K₂CO₃ is a base that ensures a quicker start of the Maillard reaction, but does not cause undesirable prepolymerization of the glue. Preferably the bases also comprise K₂CO₃, and even more preferably the bases comprise only K₂CO₃. Prepolymerization means the polymerizing of the glue prior for example to the forming, for example pressing, of the board. The addition of K₂CO₃ does not cause an undesirable increase in viscosity of the glue. Other bases, for example the strong bases NaOH and KOH, may also be used. The bases may also comprise Na₂CO₃ and/or Na₂HPO₄ and for example comprise only one of these said bases. NaOH and KOH may cause undesirable prepolymerization and thus boards with reduced technical properties, so that these are less suitable. It is also possible to use two or more different bases. When use is made of a prereact as described above, then this prereact preferably does not comprise said bases.

More preferably, the board comprises one or more layers, wherein at least one said layer comprises said cellulose-containing materials and said cured glue, wherein preferably for this layer, the percentage by weight of bases to cellulose-containing materials is between 0.03 and 1, preferably between 0.1 and 1, preferably between 0.4 and 1, even more preferably between 0.15 and 0.25. Thus, the percentage by weight of K₂CO₃ relative to cellulose-containing materials may be between 0.1 and 1, preferably between 0.15 and 0.25. This percentage by weight refers here to the amount of dry matter of the bases, for example the amount of K₂CO₃, that is added during formation of the glue in the dry matter content of the cellulose-containing materials that were used for forming the board. The percentage by weight of K₂CO₃ relative to cellulose-containing materials may for example be between 0.05 and 0.1, for example 0.07 or 0.08. These are values which are extremely suitable for MDF, but are also usable for other boards. The percentage by weight of K₂CO₃ relative to cellulose-containing materials may for example be between 0.2 and 0.3, and for example 0.21, 0.22, 0.25 or 0.26. These are values which are extremely suitable for chipboards, but are also usable for other boards.

Also more preferably, the ratio of K₂CO₃ to the total dry weight of amines and carbohydrates is between 0.01 and 0.2, preferably between 0.02 and 0.1, for example 0.04. This ratio can also be lower and can be between 0.005 and 0.01, for example 0.08. This ratio relates to the ingredients used during formation of the glue. For formation of the glue, K₂CO₃ is preferably prepared as an aqueous solution for example of at least 40 wt % K₂CO₃, to promote addition and good mixing. Thus, an aqueous solution with 50 wt % K₂CO₃ or 60 wt % K₂CO₃ may be used for forming the glue.

In a preferred embodiment the additives comprise salts of a chloric acid, for example salts of a hypochlorous acid. The additives can also comprise a chloric acid per se, such as HCl. Salts of a hypochlorous acid promote the formation of Strecker degradation products during the Maillard reaction, so that boards with greater rigidity can be obtained and/or the same rigidity with less glue. It was found, surprisingly, that especially sodium hypochlorite (NaOCl) has a positive influence. The salts of a hypochlorous acid thus preferably comprise and even more preferably are NaOCl. Other examples of possible salts of hypochlorous acid are potassium hypochlorite and calcium hypochlorite. It is also possible to use two or more different said salts.

More preferably, the board comprises one or more layers, wherein at least one said layer comprises said cellulose-containing materials and said cured glue, wherein preferably for this layer, the percentage by weight of salts of a chloric acid (or a chloric acid per se) to cellulose-containing materials is between 0.01 and 1, for example between 0.1 and 1, for example between 0.02 and 0.2 or between 0.1 and 0.2. Possible percentages by weight are 0.01 or 0.02 or 0.03. The percentage by weight of NaOCl to cellulose-containing materials may be between 0.1 and 1, preferably between 0.1 and 0.2. This percentage by weight refers here to the amount of dry matter of salts of a hypochlorous acid, for example the amount of NaOCl, that was added during formation of the glue based on the dry matter content of the cellulose-containing materials that were used for forming the board. If operation is performed with a prereact, then these salts of a chloric acid (or the chloric acid per se) for example form part of the prereact.

Also more preferably, the ratio of NaOCl to the total dry weight of amines and carbohydrates is between 0.01 and 0.2, preferably between 0.02 and 0.1. The ratio of HCl to the total weight of amines and carbohydrates is for example between 0.001 and 0.003. These ratios relate to the ingredients used during formation of the glue. For formation of the glue, NaOCl is preferably used in aqueous solution for example of at least 40 wt % NaOCl, to promote addition and good mixing. Thus, an aqueous solution with 50 wt % NaOCl or 60 wt % NaOCl may be used for forming the glue.

In a much preferred embodiment, the additives comprise crosslinkers, and these crosslinkers preferably comprise intermediates that arise during the Maillard reaction between amines and carbohydrates. To form the glue, said amines that have not yet reacted with a reducing sugar, said carbohydrates, and additionally said crosslinkers, will be provided. The reactivity and thus the quality of the glue are increased by means of these crosslinkers. The crosslinkers preferably comprise at least one aldehyde group and at least one carboxyl group and are then both an aldehyde and a carboxylic acid. When the crosslinkers are used in the Maillard reaction, these crosslinkers are regarded as Maillard reactants. Also, by adding said intermediates actively, and thus not waiting until these intermediates have formed during the Maillard reaction, it is ensured that various reaction pathways of the Maillard reaction are already present directly at the start.

More preferably, the crosslinkers are selected from the group comprising: α-hydroxyaldehydes, glyceraldehyde and α-dicarbonyls. The best results are obtained with α-dicarbonyls, since they have the most positive influence on the reactivity of the glue. These α-dicarbonyls may be for example dialdehyde and/or glyoxal and/or methylglyoxal and/or deoxyosones. α-Dicarbonyls react with the amines present to form AGE products (Advanced Glycation End products), which may be classified as melanoidins if the molecular weight is higher than 10 kilodalton.

When said crosslinkers are intermediates that are formed in the Maillard reaction between amines and carbohydrates, these intermediates may have an influence on the viscosity of the glue that is used for forming the boards. Preferably, this is therefore taken into account during formation of the glue, thus during mixing of the various ingredients. Thus, it is possible to choose when these crosslinkers are added and/or how the mixing takes place. Thus, these crosslinkers may be added during formation of the aforementioned prereact. These crosslinkers may also be added after formation of the prereact, but prior to addition of the remaining amines to the prereact. These crosslinkers may even be added last, thus after addition of the remaining amines to the prereact. Preferably, the crosslinkers are added prior to addition of the remaining amines. It is also possible to dose the crosslinkers to the cellulose-containing materials separately.

More preferably, the board comprises one or more layers, wherein at least one said layer comprises said cellulose-containing materials and said cured glue, wherein preferably in this layer the percentage by weight of said crosslinkers relative to cellulose-containing materials is between 0.02 and 0.16, preferably between 0.04 and 0.08. This percentage by weight refers here to the amount of dry matter of crosslinkers, for example the amount of α-dicarbonyls, being for example dialdehyde and/or glyoxal and/or methylglyoxal and/or deoxyosones, that were added during formation of the glue relative to the dry matter content of the cellulose-containing materials.

Also more preferably, the ratio of α-dicarbonyls, for example such as the ratio of dialdehyde and/or glyoxal and/or methylglyoxal and/or deoxyosones, to the total dry weight of amines and carbohydrates is between 0.01 and 0.20, preferably between 0.02 and 0.1. This ratio relates to the ingredients used during formation of the glue. For formation of the glue, glyoxal, or another said α-dicarbonyl, is preferably prepared as an aqueous solution of for example at least 30 wt % glyoxal, or another said α-dicarbonyl, to promote addition and good mixing. Thus, an aqueous solution with 40 wt % glyoxal or 50 wt % glyoxal may be used for forming the glue.

In a specific embodiment, the additives comprise metal-containing components, for example metal oxides and/or metal hydroxides and/or chelate-forming metal salts. With the aid of these metal-containing components, polymerization is intensified and/or accelerated under the effect of heat, with very strong boards as a result. The percentages by weight of said metal-containing components relative to cellulose-containing materials is for example between 0.01 and 0.2, preferably between 0.025 and 0.1. Additionally, addition of Ca(OH)₂, Mg(OH)₂ or CaCl₂) may provide curing of polymers formed after the pressing of the board, which contributes to the rigidity and strength of the boards.

In a preferred embodiment, the additives comprise amine crosslinking agents, wherein preferably these amine crosslinking agents are selected from the group comprising polyketones, polyesters, isocyanate dispersions, epoxides, glyoxal and other dialdehydes. When use is made of a prereact as described above, then this prereact may or may not comprise said amine crosslinking agents. For example, the prereact may comprise epoxide.

More preferably, the board comprises one or more layers, wherein at least one said layer comprises said cellulose-containing materials and said cured glue, wherein preferably for this layer, the percentage by weight of said amine crosslinking agents to cellulose-containing materials is between 0.05 and 0.25, for example between 0.07 and 0.19. For MDF (or other boards), possible percentages by weight are for example 0.17 or 0.18. For chipboards (or other boards), possible percentages by weight are for example between 0.07 and 0.12.

A second aspect of the invention is a board, optionally as defined in one or more of the embodiments of the first aspect presented above, comprising cellulose-containing materials, such as vegetable fibres and/or wood chips and/or wooden parts, and a cured glue that bonds these cellulose-containing materials together, wherein the cured glue is derived from a glue based on amines and carbohydrates and the glue comprises Maillard reaction products derived from the Maillard reaction between these amines and carbohydrates, wherein at least a proportion of the amines is selected from the group comprising: hyperbranched polyamides or chain amines; and wherein preferably, at least a proportion of the amines are hyperbranched polyamides. The chain amines may for example comprise triethylene tetramine (TETA).

In the case of boards from the prior art, usually only HDMA is used as the source of amines. With HDMA it is possible to manufacture boards of a certain quality. However, the production of HDMA has a high carbon footprint, because fossil raw materials are necessary for manufacturing HDMA industrially. In addition, HDMA is corrosive. TETA is a good alternative to HDMA, but the production of TETA usually takes place with fossil raw materials.

It was found, surprisingly, that for glues based on amines and carbohydrates, use may be made of hyperbranched polyamides as an amine source. It is thus possible that at least a proportion of the amines, and preferably at least 50% of the amines, even more preferably at least 70 wt % of the amines, and most preferably at least 90 wt % of the amines, are hyperbranched polyamides. The remaining amines are then for example HDMA or TETA or a combination of HDMA and TETA. It is also possible that all amines are hyperbranched polyamides. It is also surprising that glues of this kind have particularly good adhesiveness. In addition, the production of boards with the aid of this glue may take place similarly to the production of said boards with conventional urea formaldehyde glues (UF glues). It is thus also possible to change over to a glue based on carbohydrates and amines comprising hyperbranched polyamides, without altering the production process too much. These boards are obtained for example by providing the cellulose-containing materials with the glue and then pressing the cellulose-containing materials provided with glue to sheet-form material, wherein this sheet-form material is for example sawn into boards or already forms a board with the desired dimensions. Pressing preferably takes place at an elevated temperature, wherein this temperature may be up to more than 200° C.

Even more surprisingly, it was found that boards comprising cellulose-containing materials that have been bonded together with a glue based on carbohydrates and amines comprising hyperbranched polyamides may display better technical characteristics than boards of this kind comprising glues of this kind wherein the amines only comprise HDMA. Thus, a higher stiffness (N/mm²) and transverse tensile strength (N/mm²) may be obtained and/or a higher water resistance.

Highly branched polyamides (hyperbranched polyamides) are highly branched three-dimensional macromolecules. High/strong branching means that the polyamides are not linear and it also means that there is a significant number of branchings. This signifies that more than 3, preferably more than 5 and even more preferably more than 10 branchings are present in the polyamide macromolecule. Said polyamides may be bio-based. The hyperbranched polyamides may for example be based on polycondensed amino acids, wherein these amino acids are for example produced with the aid of bacteria. In order to form these hyperbranched polyamides, it is possible to choose to block no or virtually no groups or positions of the amino acid. It is thus possible to choose to not block the a position and/or the & position of the amino acid. Bacteria, such as Corynebacterium (Gram-positive) or Escherichia coli (Gram-negative), can by fermentation convert amino acids chemically in a directed manner for example mainly to lysine and a proportion of glutamine. Since in this case the amines in the glue comprise hyperbranched polyamides, and the glue also largely consists of sugars, this glue thus also contributes to the sustainability of said boards. In addition, this glue does not need to comprise any formaldehyde and preferably this glue does not comprise any formaldehyde, so that there is also no problem with possible release of formaldehyde by this glue. When the hyperbranched polyamides are based on polycondensed amino acids, it is not necessary that these are only based on one type of amino acid. When use is made of bacteria that for example form mainly lysine and a small proportion of other amino acids such as glutamine, both the lysine and the glutamine may be used for the production of the hyperbranched polyamides, so that an additional purification step of the amino acids is superfluous and the production of the hyperbranched polyamides can take place in an ecological manner.

Preferably use is made of only one first type of glues for forming the boards, namely glues based on said carbohydrates and amines, but the boards may also comprise other types of glues. Thus, use may be made of a glue mixture comprising the first type of glue and one or more other types of glues, and/or the board may be multilayer, wherein the first type of glue is used for one said layer and another type of glue is used for another said layer. Examples of other glues are for example conventional UF glues, MUF glues, MUPF glues, pMDI glues, polyurethane glues, polyvinylbutyral glues, polyacrylate glues, etc. Polyurethane glues may for example be used to increase water resistance and/or flexibility. It is also possible that a board is formed with various glues of the first type of glue. Thus, the board may be multilayer, wherein various glues, but for example all glues based on carbohydrates and amines, are used for the various layers. These last-mentioned various glues may differ on all kinds of surfaces. A non-exhaustive list of possible differences is given hereunder, wherein these differences are combinable with one another so long as this is not contradictory: dry matter content, the amount of hyperbranched polyamides, the average molecular weight of the hyperbranched polyamides—preferably the number average molecular weight—, amines—which and quantities—, carbohydrates—which and quantities—, additives—which and quantities—, solvent—water or solvent.

In a preferred embodiment said hyperbranched polyamides are obtained by polycondensation of amino acids, wherein these amino acids are preferably selected from the group containing arginine, glutamine, asparagine and lysine. The hyperbranched polyamides are obtained here via peptide bonds, wherein for example no preference is given to functional groups of the amino acids. Preferably, no positions on the amino acids are blocked during the polycondensation. As a result, a complex network of polyamides is obtained that can serve well as amine for the Maillard reaction. The hyperbranched polyamides are for example obtained from the polycondensation of mainly lysine. The hyperbranched polyamides are then for example hyperbranched amino acids which comprise more than 80 wt %, preferably more than 90 wt %, of lysine. Lysine is a basic amino acid that is cationic in a neutral medium. Lysine is for example obtained by fermentation making use of bacteria such as a Corynebacterium or Escherichia coli bacterium. During the production of lysine, smaller amounts of other amino acids may also be formed such as glutamine. Through the choice of the bacteria, the nutrients and the fermentation conditions, the desired amino acids may be formed in a directed manner. For this fermentation, several carbohydrate sources may be used, such as sucrose, glucose, cellulose, hemicellulose, starch or lignin. As ammonium source for the fermentation, mixtures of ammonium salts, such as ammonium sulphate or diammonium phosphate, are often used. Ammonium sulphate may be obtained as a by-product in manure processing or after the stripping of ammonia-containing gases. In other words the production of amino acids, such as lysine, may take place entirely or largely on the basis of bio-based raw materials and/or waste substances. The hyperbranched polyamides obtained by polycondensation of amino acids may be obtained by polycondensation of one, two, three or all four of said amino acids from the group comprising arginine, glutamine, asparagine and lysine. It is also possible for the hyperbranched polyamides to be obtained by polycondensation of amino acids, which are selected from the group comprising arginine, glutamine, asparagine and lysine, and one or more other amino acids.

In a specific embodiment, the hyperbranched polyamides comprise a first group of hyperbranched polyamides with an average molecular weight between 500 and 100000 g/mol, preferably between 5000 and 50000 g/mol and even more preferably between 10000 and 25000 g/mol, wherein the first group of hyperbranched polyamides preferably makes up at least 60 wt %, even more preferably at least 65 wt %, even more preferably at least 70 wt %, even more preferably at least 75 wt % and most preferably at least 80 wt % of the hyperbranched polyamides. The reactivity of the hyperbranched polyamides is optimum if the average molecular weight is higher than 5000 g/mol, and gluing can take place very well when the average molecular weight is lower than 50000 g/mol. This then also allow good production of the boards. The average molecular weight of hyperbranched polyamides may be determined, for example, by low-angle laser light scattering (LALLS). As an alternative or in addition, the average molecular weight may be determined by gel permeation chromatography (GPC). Preferably, in this description, the average molecular weight refers to the number average molecular weight.

In a preferred embodiment the board comprises one or more layers, wherein at least one said layer comprises said cellulose-containing materials and said glue, wherein preferably in this layer the percentage by weight of hyperbranched polyamides relative to cellulose-containing materials is between 0.5 and 4, preferably between 0.5 and 3, for example between 1 and 2. Possible percentages by weight for MDF (or other boards) are for example between 3 and 3.5. Possible percentages by weight for chipboard (or other boards) are for example between 1.8 and 2.2. At these percentages by weight the cellulose-containing materials are preferably dried cellulose-containing materials such as dry wood not comprising any residual moisture. The weight ratio is preferably a weight ratio based on dry matter weight. Here, only 1 layer, or only a number of layers, may comprise cellulose-containing materials and a said glue, whereas other layers then for example comprise another glue. Preferably all said layers comprise cellulose-containing materials and a said glue based on carbohydrates and amines.

In a specific embodiment the board comprises three or more layers, being two outer covering layers, and one or more central layers, wherein at least one central layer comprises said cellulose-containing materials and said glue, and wherein the covering layers each comprise cellulose-containing materials and a glue based on carbohydrates and amines comprising hyperbranched polyamides, wherein the weight ratio of hyperbranched polyamides to cellulose-containing materials in the covering layers is higher than the weight ratio of hyperbranched polyamides to cellulose-containing materials in the last-mentioned central layer. The weight ratio is preferably a weight ratio based on dry matter weight. Thus, the percentage by weight of hyperbranched polyamides relative to cellulose-containing materials in the covering layers may for example be between 2 and 3 and the percentage by weight of hyperbranched polyamides relative to cellulose-containing materials in a said central layer may be between 0.5 and 2. The glue used for the covering layers may be the same glue as the glue used for the one or more said central layers. However, it is possible that other glues are used for the various layers, but for example always glues based on carbohydrates and amines. The board may for example be a 3-layer chipboard comprising two outer covering layers with less coarse wood chips and a central layer with coarser wood chips. The central layer may comprise recycled wood chips. Chipboards of this kind may be manufactured for example using press plates at temperatures between 170° C. and 245° C., at a pressure between 2 and 5 N/mm², for at least 3 seconds, preferably at least 5 seconds, per mm of board thickness. The composition of the cellulose-containing materials may be different per layer. The one or more central layers and/or the covering layers may for example comprise recycled cellulose-containing materials.

In a particular embodiment the hyperbranched polyamides comprise a first group of hyperbranched polyamides and a second group of hyperbranched polyamides, wherein the average molecular weight of the first group of hyperbranched polyamides is at least 3 times higher, preferably at least 5 times higher than the average molecular weight of the second group of hyperbranched polyamides and/or wherein the average molecular weight of the first group of hyperbranched polyamides is at most 15 times higher, preferably at most 10 times higher than the average molecular weight of the second group of hyperbranched polyamides. The first group of hyperbranched polyamides form here the high-molecular-weight hyperbranched polyamides and the second group of hyperbranched polyamides form the low-molecular-weight hyperbranched polyamides. The combination of high-molecular-weight hyperbranched polyamides and low-molecular-weight hyperbranched polyamides improves the performance of the glue, in both reactivity and technical characteristics. Said high-molecular-weight hyperbranched polyamides have for example an average molecular weight of at least 5000 and preferably at least 10000 g/mol, for example an average molecular weight between 5000 and 50000 g/mol, preferably between 10000 and 25000 g/mol. The low-molecular-weight polyamides have for example an average molecular weight between 500 and 5000 g/mol. By means of this combination, the further polymerization of the glue during the pressing of the board is accelerated. The pumpability of the glue is also better. The glue is also better able to wet the cellulose-containing material, as a result of which the distribution of the glue on the cellulose-containing material is better and the gluing proceeds better. We talk here about groups of hyperbranched polyamides with an average molecular weight. Not all macromolecules from the same group have the same molecular weight. This is for example a consequence of the production of these hyperbranched polyamides. In the polycondensation of amino acids, not all amino acids will obtain the same reactions, being the same branchings, so that the hyperbranched polyamides obtained have various molecular weights. The hyperbranched polyamides from one and the same group are obtained by for example the same production, wherein for example for the first group of hyperbranched polyamides the polycondensation takes place for a longer time than for the second group of hyperbranched polyamides, so that the average molecular weight of the first group of hyperbranched polyamides is higher than the average molecular weight of the second group of hyperbranched polyamides. Preferably, said two groups of hyperbranched polyamides are obtained from two different productions. The average molecular weight of hyperbranched polyamides may be determined, for example, by low-angle laser light scattering (LALLS). As an alternative or in addition, the average molecular weight may be determined by gel permeation chromatography (GPC). Preferably, in this description, the average molecular weight refers to the number average molecular weight.

More preferably, the second group of hyperbranched polyamides makes up between 5 and 30 wt % of the total weight of the hyperbranched polyamides, preferably between 10 and 20 wt %.

In a specific embodiment, the hyperbranched polyamides comprises virtually only high-molecular-weight hyperbranched polyamides, being hyperbranched polyamides with for example an average molecular weight of at least 5000 and preferably at least 10000 g/mol, for example an average molecular weight between 5000 and 50000 g/mol, preferably between 10000 and 25000 g/mol. “Virtually only” indicates that, if there is a second group of hyperbranched polyamides with a low molecular weight as presented above and/or if there are low-molecular-weight hyperbranched polyamides—e.g. hyperbranched polyamides with a molecular weight for example lower than 5000 g/mol—, the percentage by weight of this second group and/or of the low-molecular-weight hyperbranched polyamides relative to the total weight of hyperbranched polyamides is preferably smaller than 0.1, preferably smaller than 0.05, even more preferably smaller than 0.005, and most preferably that this second group is absent.

In a much preferred embodiment, the glue comprises amine crosslinking agents, wherein preferably these amine crosslinking agents are selected from the group comprising polyketones, polyesters, isocyanate dispersions, epoxides, glyoxal and other dialdehydes. These amine crosslinking agents provide additional crosslinks between the hyperbranched polyamides during the forming of the boards, which ensures good properties of the formed board. These amine crosslinking agents, if for example they comprise glyoxal and/or dialdehydes, also form part of the crosslinkers as described above. The amine crosslinking agents may thus not only provide additional crosslinks between the hyperbranched polyamides, but also additional crosslinks in the Maillard reaction.

Said amine crosslinking agents are or comprise for example polyesters, wherein these polyesters are preferably dispersed and/or unsaturated polyesters. These unsaturated polyesters are for example highly branched, so that they have good solubility and do not adversely affect the viscosity of the glue used for forming the boards. During the production of the boards, wherein use is made of pressing, the acidity of the polyesters is preferably brought towards the acidity of the polyamides or stabilized, so that there are no acid/base reactions, thus undesirable prepolymerization, prior to pressing.

The glue may comprise one or more types of amine crosslinking agents. During the pressing of the boards, these amine crosslinking agents ensure better and quicker gluing between the cellulose-containing materials, so that the board obtained has the necessary rigidity and strength and the bond between the cellulose-containing materials does not break undesirably. In addition, by means of these amine crosslinking agents the pressing time can be further shortened, and the technical characteristics of the finished product, such as chipboard, OSB or MDF, increase. The technical characteristics are for example bending strength, tensile strength, compressive strength and water resistance.

Said amine crosslinking agents are or comprise for example epoxides. Excellent results are obtained by means of epoxides, such as diepoxides or triepoxides or polyepoxides or a combination of various aforementioned epoxides. These epoxides, for example the diepoxides or the triepoxides, may for example comprise one or more oxirane end groups and preferably comprise two or more oxirane end groups. These epoxides may for example be prepared via bio-based routes from lignin or aniline, such as glycerol diglycidyl ether, and/or ethylene glycol diglycidyl ether. These epoxides may for example comprise diglycidyl ether of vanillyl alcohol and/or phloroglucinol tris epoxy. It is known that epoxides react with amines. Thus, tertiary amines are used as hardener component with epoxy resins. However, it is exceptional that hyperbranched polyamides can be brought into contact with epoxides without undesirable prepolymerization after the gluing of the cellulose-containing material and prior to the pressing of the board. Preferably an over-stoichiometric amount of hyperbranched polyamides is brought into contact with epoxides. In the case of hyperbranched polyamides, the epoxides are mainly only active on adding pressure and temperature in the press. The addition of epoxides to hyperbranched polyamides leads to barely any increase in the viscosity of the glue. Therefore the pressing of the board is not hampered and very good bonding can be brought about between the cellulose-containing materials. These amine crosslinking agents may already be mixed beforehand with the hyperbranched polyamides of the glue used and may be stored like this. The amine crosslinking agents may, however, also be combined shortly before gluing with the hyperbranched polyamides of the glue used. The glue used is then for example two-part, comprising a first part comprising the hyperbranched polyamides and a second part comprising amine crosslinking agents, wherein these two parts are only combined prior to the gluing or during the gluing of the cellulose-containing materials. Said amine crosslinking agents may also be regarded as separate ingredients, separately from the glue used in the production of boards, wherein the glue used then, together with the amine crosslinking agents, forms the cured glue based on hyperbranched polyamides present in the board.

More preferably, the weight ratio of amine crosslinking agents to the hyperbranched polyamides is between 0.02 and 0.15, for example between 0.02 and 0.08. Thus, for example between 3 and 7 wt % epoxides or between 3 and 6 wt % epoxides, for example 4 or 5 or 6 wt % epoxides, may be present relative to hyperbranched polyamides. A higher proportion of amine crosslinking agents contributes to the water resistance of the glue and thus of the board comprising this glue. The content of the amine crosslinking agents should also not be too high, since this may cause prepolymerization of the glue, prior to the pressing of the board. This weight ratio ensures optimum technical characteristics, more specifically better tensile strength, bending strength and compressive strength and better water resistance. Boards of this kind are thus not only suitable for applications in dry interior conditions (service class 1), but also is extremely suitable in damper spaces, such as moist interior spaces such as bathrooms (service class 2). These boards may meet the current specifications of the relevant European standards EN 312, EN 300 or EN 622-5.

The amines make up for example between 15 and 50 wt % of the total weight of amines and carbohydrates, preferably between 30 and 40 wt %. The carbohydrates then make up between 50 and 85 wt % of the total weight of amines and carbohydrates, preferably between 60 and 70 wt %. The amines preferably comprise at least 80 wt %, preferably at least 90 wt %, and most preferably 95 wt %, hyperbranched polyamides, wherein these hyperbranched polyamides preferably have an average molecular weight higher than 500 g/mol, preferably higher than 5000 g/mol, and even more preferably higher than 10000 g/mol, and/or wherein these hyperbranched polyamides preferably have an average molecular weight lower than 100000 g/mol, even more preferably lower than 50000 g/mol, and most preferably lower than 25000 g/mol.

According to a third aspect, the invention also relates to a glue for bonding cellulose-containing materials, such as vegetable fibres and/or wood chips and/or wooden parts, to form boards, wherein the glue is based on amines and carbohydrates, wherein the glue comprises additives for controlling the Maillard reaction. This glue is the glue that is used for manufacturing boards as described above in the first aspect. The advantages and embodiments of the board presented above relating to the glue are thus also applicable to this glue. It was found, surprisingly, that such a glue is extremely suitable for gluing cellulose-containing materials, such as wood fibres or other vegetable fibres, wood chips, layers of wood and wood flakes together to form boards by pressing. Here, the amines and carbohydrates form Maillard reactants that will react with one another during the Maillard reaction to form Maillard reaction products. This glue may also be used for impregnating paper to form impregnated paper. Such impregnated paper is extremely suitable for forming a laminate comprising an MDF/HDF/chipboard substrate and one or more impregnated papers bonded to this substrate, or for forming an HPL (high pressure laminate) consisting of two or more bonded-together impregnated papers, or an HPL board (compact board) comprising at least 5, preferably at least 10, even more preferably at least 15, bonded-together impregnated papers. This invention therefore relates to an impregnated paper impregnated with the aforementioned glue.

After curing, for example by pressing, the glue comprises Maillard reaction products derived from the Maillard reaction between these amines and carbohydrates. Said additives control the Maillard reaction in the desired direction. The glue is based on said amines, carbohydrates and additives. This means that these amines, carbohydrates and additives will be provided during formation of the glue. Percentages, amounts, and proportions of these amines, carbohydrates and additives are always expressed here on the basis of the amounts of dry matter that were provided for formation of the glue. This is because during formation of the glue it is possible that these amines and carbohydrates will already react (partially) with one another, prior to the use of the glue for forming the boards.

The additives may for example increase the reactivity of the glue and/or counteract undesirable prepolymerization and/or increase the adhesiveness of the cured glue. The additives thus provide a better glue.

The Maillard reaction is the general term for a complex series of chemical reactions that occur between reducing sugars and amines. Here, the carbohydrates and the amines form Maillard reactants. Said additives may or may not be used in the Maillard reaction, and thus may or may not form part of the Maillard reactants. One or more types of additives may be used.

Here, “amines” means chemical compounds that comprise at least one amine atomic group and so are a source of amines.

The amines make up for example between 15 and 50 wt % of the total weight of amines and carbohydrates, for example between 15 and 40 wt %, preferably between 20 and 30 wt %. The carbohydrates then make up between 50 and 85 wt % of the total weight of amines and carbohydrates, preferably between 70 and 80 wt %. The amines may for example comprise diamines such as hexamethylenediamine (HDMA) and/or hyperbranched polyamides. The amines make up for example 22, 23, 24, 25, 26, 27, 28, 35, 36, 37 or 38 wt % of the total weight of amines and carbohydrates.

The carbohydrates are and/or are converted to reducing sugars. Reducing sugars are necessary for the Maillard reaction. Thus, use may be made of sucrose, which is converted to glucose and fructose. Sucrose is a widely occurring sugar and is a cheap bio-based source of carbohydrate. The carbohydrates may also be invert sugar. The carbohydrates may also comprise only glucose or only fructose. Use may thus be made of a 65 to 75 wt % solution of invert sugar in water, for example a 70 wt % solution of invert sugar in water. This solution is then brought into contact with the amines.

Preferably the additives comprise bases for adjusting the pH. By means of bases, the pH during the Maillard reaction is controlled and it is thus achieved that the desired Maillard reaction products are formed. It was found, surprisingly, that K₂CO₃ is a very suitable base to use as an additive. K₂CO₃ is a base that ensures a quicker start of the Maillard reaction, but does not cause undesirable prepolymerization of the glue. Preferably the bases also comprise K₂CO₃ and even more preferably the bases comprise only K₂CO₃. Prepolymerization means the polymerizing of the glue prior to for example the forming, for example the pressing, of the board. The addition of K₂CO₃ does not cause an undesirable increase in viscosity of the glue. Other bases, for example the strong bases NaOH and KOH, may also be used. The bases may also comprise Na₂CO₃ and/or Na₂HPO₄ and for example comprise only one of these said bases. NaOH and KOH may cause undesirable prepolymerization and thus boards with reduced technical properties, so that these are less suitable. It is also possible to use two or more different bases.

More preferably the bases make up between 0.05 and 20 wt % of dry matter content of the glue, for example between 1 and 20 wt %, even more preferably between 2 and 10 wt % and most preferably between 3 and 5 wt %.

In a preferred embodiment the additives comprise salts of a chloric acid, for example salts of a hypochlorous acid. Salts of a hypochlorous acid promote the formation of Strecker degradation products during the Maillard reaction, so that boards with greater rigidity may be obtained and/or the same rigidity but with less glue. It was found, surprisingly, that especially sodium hypochlorite (NaOCl) has a positive influence. The salts of a hypochlorous acid thus preferably comprise and even more preferably are NaOCl. Other possible salts of a hypochlorous acid are potassium hypochlorite and calcium hypochlorite. In addition or instead of salts of a chloric acid, use may also be made of a chloric acid per se, such as for example HCl.

More preferably, the salts of a chloric acid, for example the salts of a hypochlorous acid, make up between 0.12 and 20 wt % of dry matter content of the glue, for example between 0.2 and 10 wt %, for example between 1 and 20 wt % or between 2 and 10 wt % or between 3 and 4 wt %.

Instead of salts of a hypochlorous acid (or in addition), HCl per se may also be added, wherein the additives then comprise HCl. HCl is a suitable additive when use is made of sucrose as carbohydrate and a prereact, since acids have a positive influence on the conversion of sucrose to glucose and fructose.

In an especially preferred embodiment, the additives comprise crosslinkers, and these crosslinkers are preferably intermediates that are formed in the Maillard reaction between amines and carbohydrates. To form the glue, the following will now be provided: said amines that have not yet reacted with a reducing sugar, said carbohydrates, and additionally said crosslinkers. By means of these crosslinkers, the reactivity and thus the quality of the glue increases. The crosslinkers preferably comprise at least one aldehyde group and at least one carboxyl group. These crosslinkers are then both an aldehyde and a carboxylic acid. When the crosslinkers are used in the Maillard reaction, these crosslinkers are regarded as Maillard reactants. By also actively adding said intermediates, i.e. the crosslinkers, and so not waiting until these intermediates are formed during the Maillard reaction, it is ensured that various reaction pathways of the Maillard reaction are already present directly at the start of use of the glue.

More preferably, the crosslinkers are selected from the group comprising: α-hydroxyaldehydes, glyceraldehyde and α-dicarbonyls. The best results are obtained with α-dicarbonyls, since they have the most positive influence on the reactivity of the glue. These α-dicarbonyls may be for example dialdehyde and/or glyoxal and/or methylglyoxal and/or deoxyosones. α-Dicarbonyls react with the amines present to form AGE products (Advanced Glycation End products), which may be classified as melanoidins if the molecular weight is higher than 10 kilodalton. The crosslinker may for example be glyoxal.

When said crosslinkers are intermediates that are formed in the Maillard reaction between amines and carbohydrates, these intermediates may have an influence on the viscosity of the glue that is used for forming the boards. This is therefore preferably taken into account during formation of the glue, thus during mixing of the various ingredients. It is thus possible to choose when these intermediates are added and/or how the mixing takes place. Thus, these intermediates may be added during formation of the aforementioned prereact.

More preferably, these crosslinkers make up between 0.3 and 3 wt % of the glue based on dry matter content, even more preferably between 0.7 and 1.6 wt %. This percentage by weight refers here to the amount of dry matter of crosslinkers, for example the amount of α-dicarbonyls, being for example dialdehyde and/or glyoxal and/or methylglyoxal and/or deoxyosones, that were added during formation of the glue.

Also more preferably, the ratio of α-dicarbonyls, for example such as the ratio of dialdehyde and/or glyoxal and/or methylglyoxal and/or deoxyosones, to the total dry weight of amines and carbohydrates is between 0.01 and 0.20, preferably between 0.02 and 0.1. This ratio relates to the ingredients used during formation of the glue. For formation of the glue, glyoxal, or another said α-dicarbonyl, is preferably prepared as an aqueous solution of for example at least 30 wt % glyoxal, or another said α-dicarbonyl, to promote addition and good mixing. Thus, an aqueous solution with 40 wt % glyoxal or 50 wt % glyoxal may be used for forming the glue.

In a specific embodiment, the additives comprise metal-containing components, for example metal oxides and/or metal hydroxides and/or chelate-forming metal salts. The percentages by weight of said metal-containing components relative to cellulose-containing materials is for example between 0.01 and 0.2, preferably between 0.025 and 0.1. Additionally, addition of Ca(OH)₂, Mg(OH)₂ or CaCl₂) may provide curing of polymers formed after the pressing of the board, which contributes to the rigidity and strength of the boards.

In a specific embodiment, the additives comprise amine crosslinking agents, wherein preferably these amine crosslinking agents are selected from the group comprising polyketones, polyesters, isocyanate dispersions, epoxides, glyoxal and other dialdehydes.

The weight ratio of amine crosslinking agents to hyperbranched polyamides may be between 0.02 and 0.15, for example may be between 0.02 and 0.08.

According to a fourth aspect, the invention also relates to a glue, optionally as presented above in the third aspect, for bonding cellulose-containing materials, such as vegetable fibres and/or wood chips and/or wooden parts, to form boards, wherein the glue is based on amines and carbohydrates, wherein at least a proportion of the amines is selected from the group comprising: hyperbranched polyamides or chain amides; and wherein the amines preferably comprise hyperbranched polyamides.

This glue is the glue that is used for manufacturing boards comprising a cured glue derived from a glue based on carbohydrates and amines, wherein the amines comprise hyperbranched polyamides and/or chain amides, as described above in the second aspect. The advantages and embodiments of these boards are thus applicable to this glue. It was found, surprisingly, that such a glue is extremely suitable for gluing together cellulose-containing materials, such as wood fibres or other vegetable fibres, wood chips, layers of wood and wood flakes, to form boards by pressing. This glue may also be used for impregnating paper to form impregnated paper. Such impregnated paper is extremely suitable for forming a laminate comprising an MDF/HDF/chipboard substrate and one or more impregnated papers bonded to this substrate, or for forming an HPL (high pressure laminate) consisting of two or more bonded-together impregnated papers, or an HPL board (compact board) comprising at least 5, preferably at least 10, even more preferably at least 15, bonded-together impregnated papers. This invention therefore relates to an impregnated paper impregnated with the aforementioned glue.

Preferably the amines comprise hyperbranched polyamides, wherein the hyperbranched polyamides make up at least 50 wt %, preferably at least 70 wt %, even more preferably 90 wt % of the amines. Thus, all amines may be hyperbranched polyamides.

These hyperbranched polyamides are preferably obtained by polycondensation of amino acids, wherein these amino acids are preferably selected from the group containing arginine, glutamine, asparagine and lysine.

In a specific embodiment, the hyperbranched polyamides comprise a first group of hyperbranched polyamides with an average molecular weight between 500 and 100000 g/mol, preferably between 5000 and 50000 g/mol and even more preferably between 10000 and 25000 g/mol and the hyperbranched polyamides more preferably comprise a second group of hyperbranched polyamides, wherein the average molecular weight of the first group of hyperbranched polyamides is at least 3 times higher, preferably at least 5 times higher than the average molecular weight of the second group of hyperbranched polyamides and/or wherein the average molecular weight of the first group of hyperbranched polyamides is at most 15 times higher, preferably at most 10 times higher than the average molecular weight of the second group of hyperbranched polyamides and wherein, even more preferably, the second group of hyperbranched polyamides makes up between 5 and 30 wt % of the total weight of the hyperbranched polyamides, preferably between 10 and 20 wt %.

In a preferred embodiment, the glue comprises amine crosslinking agents, wherein preferably these amine crosslinking agents are selected from the group comprising polyketones, polyesters, isocyanate dispersions, epoxides, glyoxal and other dialdehydes and wherein also preferably the weight ratio of amine crosslinking agents to the hyperbranched polyamides is between 0.02 and 0.15, for example between 0.02 and 0.08. These amine crosslinking agents provide additional crosslinks between the hyperbranched polyamides during the forming of the boards, which ensures good properties of the formed board. These amine crosslinking agents, if for example they comprise glyoxal and/or dialdehydes, also form part of the crosslinkers as described above. The amine crosslinking agents may thus not only provide additional crosslinks between the hyperbranched polyamides, but also additional crosslinks in the Maillard reaction. The amine crosslinking agents are or comprise for example polyesters, wherein these polyesters are preferably dispersed and/or unsaturated polyesters. The amine crosslinking agents are or comprise for example epoxides. Excellent results are obtained by means of epoxides, such as diepoxides or triepoxides. These epoxides may for example be prepared via bio-based routes from lignin or aniline, such as glycerol diglycidyl ether, and/or ethylene glycol diglycidyl ether.

For this glue, both for embodiments that do not comprise any hyperbranched polyamides or do comprise hyperbranched polyamides, the weight ratio of amines to the sum of amines and carbohydrates is preferably at most 0.4, and even more preferably at least 0.15. Thus, the weight ratio of amines to the sum of amines and carbohydrates may be for example: 0.22 or 0.23 or 0.24 or 0.25 or 0.26 or 0.27 or 0.28 or 0.35 or 0.36 or 0.37 or 0.38. When the amines are hyperbranched polyamides, then the weight ratio of amines to the sum of amines and carbohydrates is for example between 0.3 and 0.4.

The glue may comprise water as solvent and/or may also be solvent-based. During the gluing of the cellulose-containing materials, the water ensures that the cellulose-containing materials are wetted and there is even slight penetration of the cell wall. With the aid of this glue, the cellulose-containing materials can be bonded together very well, owing to the good contact between the glue and the cellulose-containing materials. By means of water as solvent, contact between the glue and the cellulose-containing materials is possible at the level of almost the entire external surface of the cellulose-containing materials.

The viscosity of the glue used for forming boards is preferably at most 20 000 mPa·s, even more preferably at most 2000 mPa·s, at 20° C. and 1.013 bar.

The amines make up for example between 15 and 50 wt % of the total weight of amines and carbohydrates, preferably between 30 and 40 wt %. The carbohydrates then make up between 50 and 85 wt % of the total weight of amines and carbohydrates, preferably between 60 and 70 wt %. The amines preferably comprise at least 80 wt %, preferably at least 90 wt %, and most preferably 95 wt %, hyperbranched polyamides, wherein these hyperbranched polyamides preferably have an average molecular weight higher than 500 g/mol, preferably higher than 5000 g/mol, and even more preferably higher than 10000 g/mol, and/or wherein these hyperbranched polyamides preferably have an average molecular weight lower than 100000 g/mol, even more preferably lower than 50000 g/mol, and most preferably lower than 25000 g/mol.

This invention also relates to a method for forming boards comprising cellulose-containing materials, such as vegetable fibres and/or wood chips and/or wooden parts, wherein cellulose-containing materials are provided and a glue is applied on these cellulose-containing materials, after which these cellulose-containing materials provided with glue are pressed to a sheet-form material for thus forming boards, wherein the glue is a glue as presented above. By means of this method, a board is obtained as described above in the first or the second aspect. All advantages and embodiments described above are thus applicable to this method. Surprisingly, the pressing to boards may proceed similarly to the pressing of cellulose-containing materials, provided with glue, to boards, wherein the glue is a conventional UF glue.

The cellulose-containing materials, for example such as wood chips, wood flakes, layers of wood, wood fibres or other vegetable fibres, are provided with glue, thus glued, for example by misting/spraying/pouring of glue on these cellulose-containing materials. The cellulose-containing materials may, prior to this, be located in an air stream or in a mixing vessel, so as to glue the cellulose-containing materials as uniformly as possible by misting and/or mechanical friction. Then the glued cellulose-containing materials are compressed in for example a continuous press or a discontinuous press, under a certain pressure, for example a pressure between 2 and 6 N/mm², preferably between 2 and 4 N/mm², at a certain temperature, for example a temperature between 160° C. and 245° C., preferably between 200° C. and 245° C., and for a certain time, for example at least 4 seconds per mm of board thickness. The glue will then bond to the cellulose-containing materials and be cured, so as to obtain a sturdy board. This glue may be single-component, wherein the glue is stored as a whole and is applied as a whole on the cellulose-containing materials. The glue may also be two-part or multipart, wherein the glue comprises two or more different parts that are stored separately, wherein these parts are combined prior to gluing and so are applied as one whole on the cellulose-containing materials or wherein these parts are applied on the cellulose-containing materials without prior combining, whether or not simultaneously.

In a specific embodiment, wherein the board comprises one or more layers, these layers are pressed together and at least one said layer comprises said cellulose-containing materials and said glue, wherein for this layer the weight ratio of glue to cellulose-containing materials is between 0.03 and 0.15, preferably between 0.04 and 0.1. The board may for example consist of three or more layers, with outer covering layers, and one or more central layers, wherein at least one central layer comprises said cellulose-containing materials and said glue, and wherein the covering layers each comprise cellulose-containing materials and a glue as presented above, wherein the weight ratio of glue to cellulose-containing materials in the covering layers is higher than the weight ratio of glue to cellulose-containing materials in the last-mentioned central layer.

In a specific embodiment, the glue comprises said crosslinkers and/or amine crosslinking agents, and/or said crosslinkers and/or amine crosslinking agents are applied on the cellulose-containing materials. When the glue itself does not comprise said crosslinkers and/or said amine crosslinking agents, application of said crosslinkers and/or said amine crosslinking agents on the cellulose-containing materials may take place after the gluing or during the gluing. Preferably the glue per se comprises said crosslinkers and/or said amine crosslinking agents. By means of said crosslinkers and/or said amine crosslinking agents, the polymerization during pressing is accelerated and the cellulose-containing materials are thus bonded together more quickly. As a result, the pressing time may be less than 10 seconds per mm of board thickness. These said crosslinkers and/or said amine crosslinking agents may or may not form part of the glue. Thus, the glue may be a single-component glue, wherein all components of the glue have already been added to each other and the glue is stored like that. The glue may also be a two-part or multipart glue, wherein the glue comprises two or more parts, which are combined prior to the gluing, or are applied together or successively on the cellulose-containing materials. In this way, undesirable prepolymerization may be avoided. Said crosslinkers and/or said amine crosslinking agents may also be regarded as separate components, which do not form any part of the glue.

In a preferred embodiment, the pressing takes place at a temperature between 150° C. and 250° C., with a pressure between 1.5 and 5 N/mm², for at least 3 seconds per mm of board thickness. The pressing time may, depending on the pressing temperature and the type of press, be for example 3 to 7 seconds per mm of board thickness. Use may be made of a continuous or a discontinuous press. Preferably, during pressing, surfaces are sprayed from below and from above with water, for example between 10 and 50 g/m² water, so as to promote heat transfer to the middle of the board and reduce the total pressing time.

In a specific embodiment, the cellulose-containing material is coated with glue by injection, spraying or through friction between the cellulose-containing materials or a combination of the techniques. Good gluing of the cellulose-containing material is thus obtained. This relates to a similar or the same gluing that is applied when using common UF glues, so that an existing gluing step of an existing production process need not or only has to be applied to a limited extent to the glue according to the invention.

This invention also relates to a method for manufacturing a glue for boards, wherein amines and carbohydrates are provided, wherein the carbohydrates and a proportion of the amines are combined and heated to form a prereact, after which the remaining amines are added to the prereact, and wherein additives are provided, wherein these additives for example are added during formation of the prereact. The additives are additives as described above such as bases and/or acids (such as HCl) and/or salts of a hypochlorous acid and/or crosslinkers and/or amine crosslinking agents and/or metal (hydr) oxides and/or metal salts. Said amines may comprise hyperbranched polyamides as described above. This prereact comprises the carbohydrates and a proportion of the amines. This prereact is preferably heated, for example to a temperature between 50° C. and 70° C., preferably between 55° C. and 65° C. (and/or the carbohydrates and/or said proportion of the amines are heated prior to the combining to form the prereact). In this way, the Maillard reaction takes place during formation of this prereact and this prereact already has a number of Maillard reaction products. Then the remainder of the amines is added to form the glue, which is then used for gluing the cellulose-containing materials. This prereact may also already comprise a number of or all additives. These additives may be added at the beginning of formation of the prereact, but are also added during formation of the prereact. For formation of the prereact, for example between 5 and 40 wt % of the amines may be provided, for example between 15 and 40 wt %, for example between 20 and 30 wt %, for example between 10 and 20 wt %, so that sufficient amines are still present in the formed glue that have not yet reacted. It is thus possible for 10, 11, 12, 13, 14, 15, 16, 17 or 18 wt % of the amines to be added during the formation of the prereact. Here, the glue may be a two-component glue, wherein the prereact makes up one component of the glue and the remaining amines, for example the hyperbranched amides, and optional additives which were not added to the prereact make up the second component of the glue. The advantage here is that these two components may be combined only in the glue-treatment machine during the forming of boards, as a result of which the risk of undesired prepolymerization is very small.

The invention therefore relates to a two-component glue, wherein this glue is based on amines and carbohydrates, wherein at least a proportion of the amines is selected from the group comprising: hyperbranched polyamides and chain amides; wherein the amines preferably comprise hyperbranched polyamides and wherein the glue also comprises a first component and a second component, wherein the first component is a prereact of at least virtually all the carbohydrates and a proportion of the amines, and wherein the second component comprises the remaining amines. The first and/or the second component may comprise one or more or all the aforementioned additives as described above, being for example acids, bases, amine crosslinking agents, crosslinkers, salts, metal-containing components. For example, the first component may already comprise an epoxide and/or the second component may comprise potassium carbonate. The amounts of amines in the first component may be the amounts for the prereact described above. This glue is usable for bonding cellulose-containing materials, such as vegetable fibres and/or wood chips and/or wooden parts, to form boards, but is also usable for impregnating paper.

An alternative embodiment of the invention relates to a glue for the bonding of insulating materials, such as glass wool, rock wool, etc., to form for example mats, wherein the glue is a glue as described above in the third or the fourth aspect. The preferred embodiments of the glue as presented above are also applicable to this alternative embodiment. With the aid of this glue, insulating material such as glass wool, rock wool, etc. is then formed. The invention thus relates to an insulating material, such as glass wool or rock wool, comprising a said glue based on amines and carbohydrates, as well as a method for manufacturing insulating material, such as glass wool or rock wool, wherein a said glue based on carbohydrates and amines is provided.

According to a variant embodiment, the invention relates to a method for producing a basic raw material comprising amino acids, wherein this basic raw material is usable for producing hyperbranched polyamides, preferably by polycondensation of the amino acids of the basic raw material. The basic raw material is preferably obtained by fermentation, wherein this fermentation is preferably carried out with bacteria. This basic raw material may be used for forming hyperbranched polyamides, for example by causing polycondensation of the amino acids present to take place at a certain temperature, for example between 120° C. and 180° C., for a number of hours, for example in the presence of optional catalysts and/or a strong base, such as KOH. Specific embodiments of the variant embodiment are presented in the following non-exhaustive list. Combinations of features from this non-exhaustive list are possible, provided they do not contradict one another:
Bacteria are provided, which are able, via fermentation, to produce amino acids in a directed manner. Thus, for example bacteria may be provided that are able to produce mainly lysine and, for example in smaller amounts, one or more other amino acids for example such as glutamine, wherein preferably the percentage by weight of other amino acids makes up at most 20%, preferably at most 10%, even more preferably at most 5%, of the total amount of amino acids produced. These bacteria thus produce a basic raw material comprising amino acids, wherein this basic raw material may be described as a lysine source of industrial quality. The standards for a lysine source of industrial quality are lower than those of a lysine source for foodstuff or feedstuff purposes;
The basic raw material comprises amino acids from the group containing arginine, glutamine, asparagine and lysine. The basic raw material may comprise one, a combination of 2, a combination of 3 or all amino acids from the aforementioned group;
The basic raw material comprising amino acids is produced via fermentation by bacteria, wherein for the fermentation, one or more carbohydrate sources are provided and one or more ammonium sources are provided. The one or more ammonium sources comprise for example one or more ammonium salts, such as ammonium sulphate or diammonium phosphate. The one or more carbohydrate sources comprise for example sucrose, glucose, cellulose, hemicellulose, starch or lignin. The carbohydrate sources are for example molasses, starch hydrolysates, waste water comprising starch, wood-containing sources, recycled sources such as recycled MDF or recycled chipboards. The result is, for example, a basic raw material in the form of a slurry, this slurry comprising amino acids. A drying step of this slurry is not necessary. The production of hyperbranched polyamides can be started without a preceding drying step of the slurry or with a limited drying step;
The basic raw material comprising amino acids is produced via fermentation by bacteria. These bacteria may for example be Corynebacterium and/or E. coli bacteria;
The basic raw material is produced by means of L-lysine producing bacterial strains. These bacterial strains may be for example Corynebacterium and/or E. coli bacteria;
The fermentation takes place at a pH between 7 and 8, preferably between 7.3 and 7.7 and/or at a temperature between 28° C. and 35° C., preferably between 30° C. and 33° C.;
The fermentation takes place in a reactor with a stirrer: “stirred tank reactor”;
The fermentation takes place in batch, fed batch mode or continuously;
Additives are added to increase the yield of a particular amino acid, such as L-lysine, in the fermentation.

For the purpose of better illustrating the features of the invention, some preferred embodiments are described hereunder, as examples without any limiting character.

A first example of a panel according to the invention is a 3-layer chipboard comprising two outer covering layers and a central layer. The central layer comprises coarse wood chips, which may or may not be derived from wood waste and/or recycled chipboards, and the covering layers comprise finer wood chips. Here, the wood chips are bonded together by means of a glue based on carbohydrates, hyperbranched polyamides and additives. These additives comprise, among other things, one or more of the following components: bases, salts of a hypochlorous acid and/or HCl, crosslinkers as defined above, amine crosslinking agents as defined above. The additives comprise for example one or more of the following components: K₂CO₃, NaOCl and/or HCl, α-dicarbonyls and epoxides. The glue may for example comprise the following percentages by weight based on dry matter content: 69% carbohydrates (for example sucrose), 23% hyperbranched polyamides, 4% K₂CO₃, 3% NaOCl and 1% glyoxal; or 59% carbohydrates (for example sucrose), 35% hyperbranched polyamides, 3.5% K₂CO₃, 0.5% HCl and 2% epoxides; or 69% carbohydrates (for example sucrose), 26.5% hyperbranched polyamides, 1% epoxides, 3% K₂CO₃ and 0.5% HCl; or 60.8% carbohydrates (for example sucrose), 36% hyperbranched polyamides, 2% epoxides, 1% K₂CO₃ and 0.2% HCl; or 59% carbohydrates (for example sucrose), 35% hyperbranched polyamides, 2% epoxides, 3.8% K₂CO₃ and 0.2% HCl. The composition of the glue of the central layer may or may not be identical to the composition of the glue of a said covering layer.

A second example of a panel according to the invention is a wood fibreboard, such as an MDF or HDF board. This wood fibreboard is single-layer and comprises wood fibres and a glue as defined in the above paragraph.

The hyperbranched polyamides are obtained by polycondensation of amino acids that comprise mainly lysine. Besides lysine, which is preferably L-lysine, for example a small amount of glutamine is present. Thus, glutamine makes up for example at most 5 wt % of the amino acids present. Said amino acids are derived from a basic raw material comprising amino acids. This basic raw material is for example obtained by fermentation with bacteria, wherein these bacteria form lysine in a directed manner.

In the 3-layer chipboard, the glue for the different layers is for example the same glue. More glue is used for the covering layers than for the central layer. This ensures that the cellulose-containing materials at the level of the covering layers do not come loose from each other undesirably. The use of more glue in the covering layers is not superfluous, since covering layers consist of finer particles, so that the total surface area to be glued increases considerably.

Preferably, operation is performed with an aforementioned prereact for forming the boards.

For purposes of illustration, some test results are discussed below for chipboards, demonstrating the advantages of various preferred embodiments of the invention:

Two tests were carried out (tests 1 and 2) on a board comprising a glue according to the prior art. This is so as to be able to compare boards according to the invention with boards according to the prior art. Then 6 additional tests (tests 3 to 8) were carried out on boards according to the invention. For all boards tested, the percentage by weight of amines in the total weight of amines and carbohydrates is always 25%. For all these boards, the same type of chips was used and the same carbohydrates were used, so as to obtain results that may be compared with one another. Use is always made of the same press and the same pressing temperature for forming the boards. The boards have the same thickness. The amines in tests 1 to 6 are HDMA. The amines in tests 7 and 8 comprise 24 wt % HDMA and 76 wt % hyperbranched polyamides. The density was measured according to EN 323, the thickness according to EN 324-1, the tensile strength according to EN 319. The bending strength and elastic modulus were measured according to EN 310.

| | wt % | | | | | | | | |
|---|---|---|---|---|---|---|---|---|---|
| | amines and | wt % | wt % | wt % | | | | | |
| | carbohydrates | K₂CO₃ | NaOCl | glyoxal | Pressing | | Tensile | Bending | E- |
| | relative | relative | relative | relative | time | Density | strength | strength | modulus |
| Test | to chips | to chips | to chips | to chips | (s) | (kg/m³) | (N/mm²) | (N/mm²) | (N/mm²) |
| 1 | 5.71 | 0 | 0 | 0 | 120 | 646 | 0.53 | 10.0 | 2270 |
| 2 | 5.00 | 0 | 0 | 0 | 105 | 692 | 0.66 | 11.6 | 2210 |
| 3 | 5.71 | 0.4 | 0 | 0 | 120 | 653 | 0.73 | 12 | 2785 |
| 4 | 5.00 | 0.4 | 0 | 0 | 105 | 690 | 0.92 | 13.6 | 2460 |
| 5 | 5.71 | 0 | 0.2 | 0 | 120 | 651 | 0.59 | 12.1 | 2760 |
| 6 | 5.00 | 0 | 0.2 | 0 | 105 | 701 | 0.68 | 11.5 | 1895 |
| 7 | 5.71 | 0 | 0 | 0.2 | 120 | 648 | 0.77 | 15.5 | 2930 |
| 8 | 5.00 | 0 | 0 | 0.15 | 105 | 738 | 1.58 | 17.4 | 2843 |

By means of K₂CO₃, better tensile strength, bending strength and elastic modulus are obtained. By means of glyoxal, among other things, better bending strength and elastic modulus were obtained. By means of hyperbranched polyamides, high tensile strength and bending strength are obtained.

1.-44. (canceled)

45. A board comprising cellulose-containing materials, and a cured glue that bonds these cellulose-containing materials together,
wherein the cured glue is derived from a glue based on amines and carbohydrates and the cured glue comprises Maillard reaction products derived from the Maillard reaction between these amines and carbohydrates,
wherein at least a proportion of the amines is selected from the group comprising:
hyperbranched polyamides and chain amines.

46. The board as in claim 45, wherein the amines at least comprise hyperbranched polyamides and the hyperbranched polyamides make up at least 50 wt % of the amines.

47. The board as in claim 46, wherein said hyperbranched polyamides are obtained by polycondensation of amino acids.

48. The board as in claim 47, wherein the amino acids are selected from the group containing arginine, glutamine, asparagine and lysine.

49. The board as in claim 45, wherein the board comprises one or more layers,
wherein at least one said layer comprises said cellulose-containing materials and said cured glue,
wherein in this layer the percentage by weight of hyperbranched polyamides to cellulose-containing materials is between 0.5 and 4.

50. The board as in claim 45, wherein the glue comprises amine crosslinking agents,
wherein these amine crosslinking agents are selected from the group comprising polyketones, polyesters, isocyanate dispersions, epoxides, glyoxal and other dialdehydes.

51. The board as in claim 50, wherein the weight ratio of amine crosslinking agents to hyperbranched polyamides is between 0.02 and 0.15.

52. The board as in claim 45, wherein the additives comprise bases.

53. The board as in claim 52, wherein the board comprises one or more layers,
wherein at least one said layer comprises said cellulose-containing materials and said cured glue,
wherein for this layer, the percentage by weight of the bases to the cellulose-containing materials is between 0.03 and 1.

54. A glue for bonding cellulose-containing materials to form boards,
wherein the glue is based on amines and carbohydrates,
wherein at least a proportion of the amines is selected from the group comprising:
hyperbranched polyamides and chain amides.

55. The glue as in claim 54, wherein the amines comprise hyperbranched polyamides and
wherein the hyperbranched polyamides make up at least 50 wt % of the amines.

56. The glue as in claim 55, wherein the hyperbranched polyamides are obtained by polycondensation of amino acids.

57. The glue as in claim 56, wherein the amino acids are selected from the group containing arginine, glutamine, asparagine and lysine.

58. The glue as in claim 54, wherein the glue comprises amine crosslinking agents,
wherein these amine crosslinking agents are selected from the group comprising polyketones, polyesters, isocyanate dispersions, epoxides, glyoxal and other dialdehydes.

59. The glue as in claim 54, wherein the weight ratio of amines to the total weight of amines and carbohydrates is at most 0.4.

60. The glue as in claim 54, wherein the additives comprise bases for adjusting the pH.

61. The glue as in claim 60, wherein the bases comprise K2CO3.

62. The glue as in claim 60, wherein the bases make up between 0.5 and 20 wt % based on dry matter content of the glue.

63. A method for forming boards comprising cellulose-containing materials,
wherein cellulose-containing materials are provided and a glue is applied on these cellulose-containing materials, after which these cellulose-containing materials provided with glue are pressed to a sheet-form material for forming boards,
wherein the glue is based on amines and carbohydrates,
wherein at least a proportion of the amines is selected from the group comprising:
hyperbranched polyamides and chain amide; and
wherein the glue at least comprises hyperbranched polyamides.

64. The method as in claim 63, wherein the board comprises one or more layers,
wherein these layers are pressed together and wherein at least one said layer comprises said cellulose-containing materials and said glue,
wherein for this layer the weight ratio of glue to cellulose-containing materials is between 0.03 and 0.10.
